(19) United States
(12) Patent Application Publication
(10) Pub. No.: US 2024/0367037 A1
(43) Pub. Date: Nov. 7, 2024

(54) HAPTIC-ENABLED GAMING CONTROLLERS

(71) Applicant: Cirrus Logic International Semiconductor Ltd., Edinburgh (GB)

(72) Inventors: Marco JANKO, Austin, TX (US); James SMITH, Austin, TX (US); Nicholas SKINNER, Austin, TX (US); Graham CURTIS, Austin, TX (US)

(73) Assignee: Cirrus Logic International Semiconductor Ltd., Edinburgh (GB)

(21) Appl. No.: 18/515,745

(22) Filed: Nov. 21, 2023

Related U.S. Application Data
(60) Provisional application No. 63/500,344, filed on May 5, 2023.

(51) Int. Cl. A63F 13/285

(52) U.S. Cl. CPC A63F 13/285

(57) ABSTRACT

A gaming controller, comprising: a haptic actuator; and a haptic driver, wherein the haptic driver is configured to drive the haptic actuator with a drive signal having a dominant frequency F2, and to control how the drive signal is applied to the haptic actuator to generate a haptic effect that at least partly emulates a desired haptic effect having a dominant frequency F1, where F2>F1.

### FIELD OF DISCLOSURE

The present disclosure relates to haptic-enabled devices and systems, in particular to haptic-enabled gaming controllers. Such devices and systems may comprise a haptic actuator and a haptic driver for driving the haptic actuator.

### BACKGROUND

Vibrational transducers find use in a range of technical fields, including in the field of haptic feedback. As is well known, haptic (or haptics) technology creates an experience of touch, or a tactile experience, by applying forces, vibrations, or motions to a user. Using a haptic transducer, forces may be applied to the user to give a haptic experience (also referred to as haptic feedback) which accompanies and/or enhances another user experience, such as an audio or visual experience, or which merely provides the user with tactile information concerning the status of an ongoing process. Haptic vibrations can provide added immersion in gaming applications, for example.

Linear resonant actuators (LRAs) are highly power efficient when operated in a narrow band at or near resonance. LRAs are also relatively fast and thus useful for precise haptic effects. For these reasons, LRAs are typically used in battery-powered mobile devices such as mobile telephones or cellphones, to provide power-efficient, strong and precise haptic feedback to the user, for example to recreate the effect of a mechanical button press. Voice coil motors (VCMs) are similar to LRAs but have a broader frequency response.

Eccentric rotating-mass motors (ERMs) are typically much slower than LRAs and VCMs and are better suited to rumble-type—or other low-frequency-haptic feedback. For these reasons, ERMs are typically used to provide low-frequency haptic effects in gaming controllers. A gaming controller or game controller may be considered a device for use with video games or entertainment systems to provide input to a video game. Controllers may be input devices that only provide input to the entertainment system or input/output devices that receive data from the entertainment system and produce a response (e.g., a haptic response, such as a rumble, or an audio response).

However, it has become desirable to adopt LRAs or VCMs to replace ERMs in gaming controllers. This creates challenges given that the frequency characteristics of LRAs and VCMs, on the one hand, and ERMs, on the other hand, are quite different.

It is desirable to address such challenges.

### SUMMARY

According to a first aspect of the present disclosure, there is provided a gaming controller, comprising: a haptic actuator; and a haptic driver, wherein the haptic driver is configured to drive the haptic actuator with a drive signal having a dominant frequency F2, and to control how the drive signal is applied to the haptic actuator to generate a haptic effect that at least partly emulates a desired haptic effect having a dominant frequency F1, where F2>F1.

F2 may be significantly greater than F1, for example with the former being above 150 Hz (e.g. at or around the resonant frequency of the haptic actuator) and the latter below 100 Hz (where the driving efficiency of the haptic actuator is particularly poor).

According to a second aspect of the present disclosure, there is provided a gaming controller, comprising: N haptic actuators HAx, where x=1 to N, and where N≥1; and a haptic driver, wherein the haptic driver is configured to: drive each of the N haptic actuators HAx with a corresponding drive signal DSx having a corresponding dominant frequency F2x; and control, for each of the N haptic actuators HAx, how its drive signal DSx is applied to its haptic actuator HAx to generate, with the N haptic actuators, a haptic effect that at least partly emulates a desired haptic effect having a dominant frequency F1, where each dominant frequency F2x is greater than F1.

According to a third aspect of the present disclosure, there is provided a haptic driver for driving a haptic actuator of a gaming controller or automotive system, the haptic driver configured to drive the haptic actuator with a drive signal having a dominant frequency F2, and to control how the drive signal is applied to the haptic actuator to generate a haptic effect that at least partly emulates a desired haptic effect having a dominant frequency F1, where F2>F1.

According to a fourth aspect of the present disclosure, there is provided a haptic-effect generation method, comprising: driving a haptic actuator with a drive signal having a dominant frequency F2; and controlling how the drive signal is applied to the haptic actuator to generate a haptic effect that at least partly emulates a desired haptic effect having a dominant frequency F1, where F2>F1.

According to a fifth aspect of the present disclosure, there is provided a system and method for driving an actuator having a resonant frequency, preferably a haptic actuator such as an LRA or a VCM, comprising: receiving an indication of a desired effect to be output by the actuator (e.g. a haptic vibration), the desired effect having a relatively low frequency, preferably where the desired effect has a primary or dominant frequency F1 lower than the resonant frequency of the actuator; generating a haptic driving signal based on the received indication, wherein the haptic driving signal has a relatively high frequency, preferably the haptic driving signal has a primary or dominant frequency F2, wherein F2>F1; and driving an actuator using the haptic driving signal, wherein the haptic driving signal is generated to emulate the feeling of the desired effect to a user.

According to a sixth aspect of the present disclosure, there is provided an integrated circuit (IC) comprising: a haptic driver output stage to be coupled with a haptic actuator; and a Digital Signal Processor (DSP) to generate a haptic driving signal to be output by the haptic driver output stage, wherein the DSP receives an indication of a haptic effect to be generated by a coupled haptic actuator, and transforms the received indication to a haptic driving signal to be output by the haptic driver output stage. Preferably, the haptic driving signal has a primary or dominant frequency higher than a primary or dominant frequency of the haptic effect to be generated.

Corresponding apparatus/device aspects, method aspects, computer program aspects and storage medium aspects are envisaged. Features of one aspect may be applied to another and vice versa.

### BRIEF DESCRIPTION OF THE DRAWINGS

Reference will now be made, by way of example only, to the accompanying drawings, of which:

FIG. 1 is a graph showing an example frequency response of an LRA;

FIG. 2 is a schematic diagram of a host embodying the present invention;

FIG. 3 is a schematic diagram useful for understanding control of an LRA, as an example haptic actuator;

FIG. 4, which is a graph showing a desired drive signal and series of LRA pulses formed by controlling application of a driving signal;

FIGS. 5A and 5B are schematic diagrams of hosts embodying the present invention, having first and second haptic actuators;

FIG. 6 presents graphs corresponding to that of FIG. 4, one for driving the first haptic actuator and the other for driving the second haptic actuator;

FIG. 7 is a graph showing a desired drive signal and a drive signal being amplitude modulated so that its envelope corresponds to the desired drive signal;

FIG. 8 is a graph corresponding to that of FIG. 7 but useful for understanding that the desired drive signal may have arbitrary waveform shape; and

FIG. 9 is a schematic diagram showing different example arrangements of haptic actuators in corresponding hosts.

### DETAILED DESCRIPTION

The description below sets forth example embodiments according to this disclosure. Further example embodiments and implementations will be apparent to those having ordinary skill in the art. Further, those having ordinary skill in the art will recognize that various equivalent techniques may be applied in lieu of, or in conjunction with, the embodiments discussed below, and all such equivalents should be deemed as being encompassed by the present disclosure.

As mentioned above, the frequency characteristics of LRAs/VCMs and ERMs are quite different.

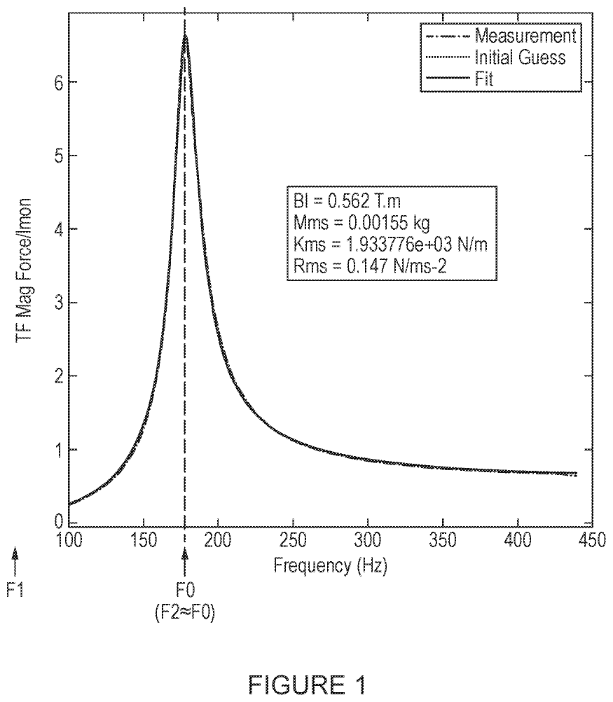

Taking LRAs as an example, FIG. 1 is a graph showing an example frequency response of an LRA, showing a distinctive ‘sharp’ resonant peak at its resonant frequency F0, in this example at around 180 Hz.

However, haptic applications deployed in gaming controllers typically seek haptic effects at a frequency F1 in the 20-80 Hz band, as indicated in FIG. 1, which is far away from the resonant frequency where the response of an LRA is typically poor/low. For example, a gain from driving signal to LRA response at F1 may be 5 or even 10 times lower than at F0. Energizing an LRA to create a strong feeling at low frequencies such as F1 requires a lot of power and could damage the driving coil of the LRA. With this in mind, gaming controllers typically employ ERMs rather than LRAs as they are more power efficient and effective at such frequencies.

Herein, as a running example, frequency F1 will be taken forward as the frequency of a desired low frequency haptic effect and frequency F2 as a relatively high frequency suitable for driving an LRA or VCM, typically at or close to the LRA/VCM resonant frequency F0. In overview, the inventors propose in a first approach creating the “feeling” of a desired low frequency haptic effect by “sampling” a corresponding low frequency drive signal using high frequency impulses or pulses. Spacing between the pulses May accommodate the desired low frequency drive signal. As a second approach, the inventors propose creating the “feeling” of the desired low frequency haptic effect by amplitude modulating a high frequency signal with a low frequency envelope. In effect, the skin/body of the user serves as a filter (a low pass filter) with the desired haptic effect being felt.

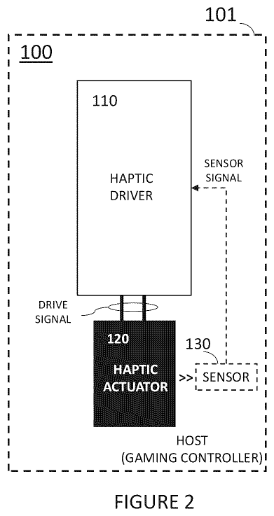

FIG. 2 is a schematic diagram of a host 100, embodying the present invention. The host 100 may be considered a host system or a host device but will be referred to simply as a host for simplicity. The present disclosure will be understood accordingly.

The host 100 may be referred to as a haptic-enabled host and may be a consumer device or system. As a running example, the host 100 will be considered a gaming controller.

As shown in FIG. 2, the host 100 may comprise an enclosure 101, a haptic driver 110, a haptic actuator 120 and, optionally, a sensor 130. The host 100 may be provided without the haptic actuator 120 and be fitted with the haptic actuator 120 subsequently. The haptic driver 110 may be provided independently of the host 100, for example to be fitted during manufacture of the host 100.

The enclosure 101 may comprise any suitable housing, casing, chassis or other enclosure for housing the various components of the host 100. Enclosure 101 may be constructed from plastic, metal, fabric and/or any other suitable materials. In addition, enclosure 101 may in some arrangements be adapted (e.g., sized and shaped) such that host 100 is readily useable by a user (i.e. a person, a consumer).

The haptic driver 110 may be or comprise a controller, signal generator and/or amplifier. The haptic driver 110 is configured to drive the haptic actuator 120 with a drive signal, as indicated. Specifically, the haptic driver 110 is configured to drive the haptic actuator 120 with a drive signal having a dominant frequency F2, and to control how the drive signal is applied to the haptic actuator 120 to generate a haptic effect that at least partly emulates or feels like a desired haptic effect having a dominant frequency F1, where F2≠F1. In the running example, F2>F1, or F2>>F1.

The haptic driver 110 may be provided as a combination of a signal generator (e.g. digital signal processor, DSP, as explained later) and a haptic driver output stage (e.g. performing signal amplification). Such a signal generator may generate a haptic drive signal, and the haptic driver output stage may be coupled to the haptic actuator 120 and amplify the haptic drive signal. The present disclosure will be understood accordingly.

Here it will be understood that the dominant frequency F2 is at or near the resonant frequency F0 of the haptic actuator 120, for efficient and reliable driving of the haptic actuator 120, and that the dominant frequency F1 is less than, or substantially less than, or far away from, the dominant frequency F2. F0 and F2 may be above 100 Hz, and further preferably above 150 Hz. For example, F0 and F2 may be in the range 170-185 Hz, and may be 180 Hz. F1 may be below 100 Hz, and may be in the range 20-80 Hz.

The haptic actuator 120 (or simply, actuator or transducer) may be or comprise an LRA and/or a VCM. The haptic actuator 120 may be implemented as a plurality of actual actuators in some arrangements. A gain from driving signal to haptic actuator response at F1 may be A times lower than at F0 or F2, where A>2, optionally where A>5, optionally where A>10.

The haptic driver 110 may be housed within enclosure 101 and may include any system, device, or apparatus configured to drive the haptic actuator 120 with the drive signal.

Control functionality of the haptic driver 110 may be implemented as digital or analogue circuitry, in hardware or in software running on a processor, or in any combination of these. Such control functionality may include any system, device, or apparatus configured to interpret and/or execute program instructions or code and/or process data, and may include, without limitation a processor, microprocessor, microcontroller, digital signal processor (DSP), application specific integrated circuit (ASIC), FPGA (Field Programmable Gate Array) or any other digital or analogue circuitry configured to interpret and/or execute program instructions and/or process data. Thus, the code may comprise program code or microcode or, for example, code for setting up or controlling an ASIC or FPGA. The code may also comprise code for dynamically configuring re-configurable apparatus such as re-programmable logic gate arrays. Similarly, the code may comprise code for a hardware description language such as Verilog™ or VHDL. As the skilled person will appreciate, the code may be distributed between a plurality of coupled components in communication with one another. Where appropriate, such aspects may also be implemented using code running on a field-(re) programmable analogue array or similar device in order to configure analogue hardware. Processor control code for execution may be provided on a non-volatile carrier medium such as a disk, CD- or DVD-ROM, programmed memory such as read only memory (Firmware), or on a data carrier such as an optical or electrical signal carrier. The haptic driver 110 or control circuitry thereof may be provided as, or as part of, an integrated circuit such as an IC chip.

The control functionality of the haptic driver 110 may be considered as a haptic-effect generation method. Such a method may comprise: driving the haptic actuator 120 with a drive signal having the dominant frequency F2; and controlling how the drive signal is applied to the haptic actuator to generate a haptic effect that at least partly emulates a desired haptic effect having a dominant frequency F1, where F2≠F1. Again, in the running example, F2>F1, or F2>>F1.

Although not shown in FIG. 1, the host 100 may comprise a further controller separate from the haptic driver 110 but in communication therewith, such as an application processor configured to generally control operation of the host 100. Alternatively, the functionality of such a further controller may be provided by the haptic driver 110. The host 100 may also comprise an input and/or output unit (I/O unit), for interaction with a user and/or with another device, and a memory. The memory may be configured to retain program instructions and/or data for a period of time, e.g. for the haptic driver 110 (and any further controller).

Control of how the drive signal is applied to the haptic actuator 120 may comprise controlling any of: when (i.e. a timing of) the drive signal is and is not applied to the haptic actuator 120; a magnitude of the applied drive signal, e.g. over time; a phase of the applied drive signal, e.g. over time; a polarity of the applied drive signal, e.g. over time; and a value of F2 (e.g. to track F0), e.g. over time. That is, any of these features or characteristics of the drive signal may be varied, controlled or adjusted over time.

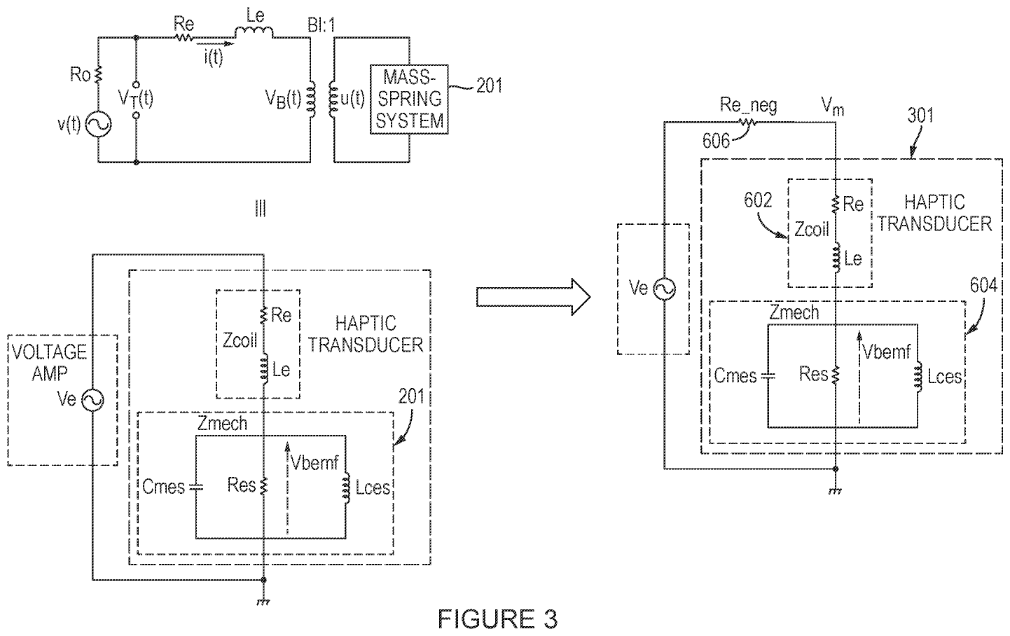

In general, control of how the drive signal is applied to the haptic actuator 120 may comprise modifying the drive signal such that a leading end of a discrete pulse of the applied drive signal has a steepened attack profile and/or such that a trailing end of a discrete pulse of the applied drive signal has a steepened braking profile. The control may comprise modifying the drive signal such that the haptic actuator behaves as if an impedance of the haptic actuator and/or the haptic driver had been modified. In this regard, the sensor 130 may be provided to enable the performance of the haptic actuator to be monitored, and to enable closed-loop control of the haptic actuator 120 to be performed. To better understand an example use of the sensor 130, reference is made to FIG. 3.

FIG. 3 illustrates, on the left-hand side, an example of an LRA (as an example of the haptic actuator 120) modelled as a linear system, including an electrically equivalent model of mass-spring system 201 of LRA. In this example, the LRA is modelled as a third order system having electrical and mechanical elements. In particular, Re and Le are the DC resistance and coil inductance of the coil-magnet system, respectively; and Bl is the magnetic force factor of the coil. The driving amplifier (corresponding to the haptic driver 110) outputs the voltage waveform V(t) with the output impedance Ro. The terminal voltage V_{T}(t) may be sensed across the terminals of the haptic transducer (haptic actuator 120), for example by way of the sensor 130. The mass-spring system 201 moves with velocity u(t).

As also shown on the left-hand side in FIG. 3, an electromagnetic load such as an LRA may be characterized by its impedance Z_{LRA} as seen as the sum of a coil impedance Z_{coil} and a mechanical impedance Z_{mech}. The coil impedance Z_{coil} may be modelled as a direct current (DC) resistance Re in series with an inductance Le. Similarly, the mechanical impedance Z_{mech} may be defined by three parameters including the resistance at resonance R_{RES}, a capacitance C_{MES}, and an inductance L_{CES}. The electrical equivalent of the total mechanical impedance is the parallel connection of R_{RES}, C_{MES}, L_{CES}.

As explained in more detail in U.S. Pat. No. 11,283,337 B2, the attack time of the back EMF of the LRA may be slow as energy is transferred to the LRA, and some “ringing” of the back EMF may occur after the driving signal has ended as the mechanical energy stored in the LRA is discharged. In the context of a haptic LRA, such behavioural characteristics may result in a “mushy” feeling click or pulse, instead of a “crisp” tactile response. The problem may result from the LRA having a high-quality factor Q with a sharp peak in impedance at a resonant frequency F0 of the transducer (cf. the frequency response of FIG. 1).

As indicated on the right-hand side of FIG. 3, the LRA may be modelled as a modified haptic transducer 301, in the same way as on the left-hand side but including a negative resistance resistor 606 with negative impedance Re_neg inserted in series with haptic transducer 301. The addition of negative impedance Re_neg may lower the quality factor Q because effectively it subtracts from DC resistance Re thereby reducing the overall DC electrical impedance.

In practice, negative resistors do not exist. Instead, a negative impedance filter (not shown, but implemented in the haptic driver 110) may comprise a digital filter configured to behave substantially like the circuit shown in on the right-hand side, including a mathematical model of negative impedance Re_neg in series with a mathematical model of haptic transducer 301. In operation, the negative impedance filter may in effect compute a voltage Vm that would occur at the junction of negative impedance Re_neg and DC resistance Re as shown (if, in fact, it were possible to place a physical resistor with negative impedance Re_neg in series with haptic transducer 301), based on a voltage across the haptic transducer 301 and/or current drawn by the haptic transducer 301 (as measured by the sensor 130). Computed voltage Vm may then be used to drive haptic transducer 301 (haptic actuator 120). Further detail in this respect, and associated techniques, are provided in U.S. Pat. No. 11,283,337 B2 (mentioned above), U.S. Pat. No. 11,121,661 B2 and U.S. Pat. No. 10,828,672 B2, the entire contents of which are incorporated herein by reference.

The sensor 130 accordingly may be any sensor capable of detecting, for example, the voltage across the haptic actuator 120 and/or the current drawn by the haptic actuator 120. The sensor 130 may in some arrangements be configured to detect the mechanical performance of the haptic actuator 120. For example, the sensor 130 may comprise at least one of: a voltmeter, an ammeter, a resistance, a microphone; an accelerometer, an inertial measurement unit, a motion sensor; a speaker; a piezoelectric sensor; a temperature sensor and a force sensor.

In some arrangements, the sensor 130 may be implemented as part of the haptic driver 110. The haptic driver 110 and/or sensor 130 accordingly may comprise monitoring circuitry arranged to monitor and track actuator characteristics, e.g. voltage, current, back EMF, temperature, and/or actuator resonant frequency. The haptic driver 110 may be configured to control or adjust the driving signal based on the monitored characteristics.

The haptic driver 110 accordingly may be configured to control how the drive signal is applied to the haptic actuator 120 such that the applied drive signal at least partly emulates a desired drive signal, the desired drive signal having the dominant frequency F1 and configured to generate the desired haptic effect. The desired drive signal and/or the desired haptic effect having the dominant frequency F1 may have at least one of: a periodic waveform; a sinusoidal, triangle, square, rectangular, positive-ramp sawtooth, or negative-ramp sawtooth waveform; a modified sinusoidal waveform, having a slow rise and fast fall; an irregular waveform; and a customised waveform, optionally defined by one or more custom parameters. It is noted at this juncture that the value of F1 may be varied, controlled or adjusted over time, to provide a haptic effect which changes over time.

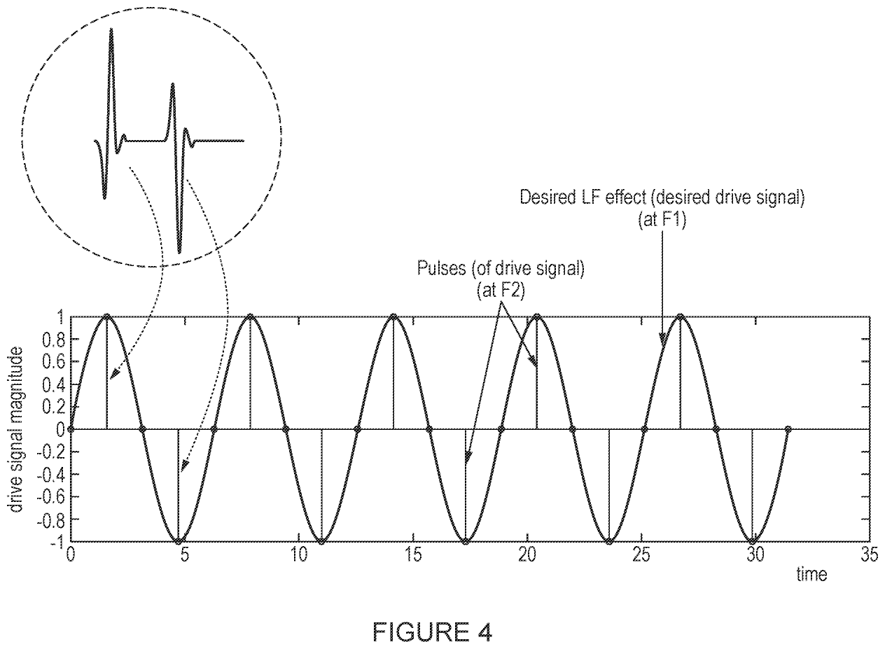

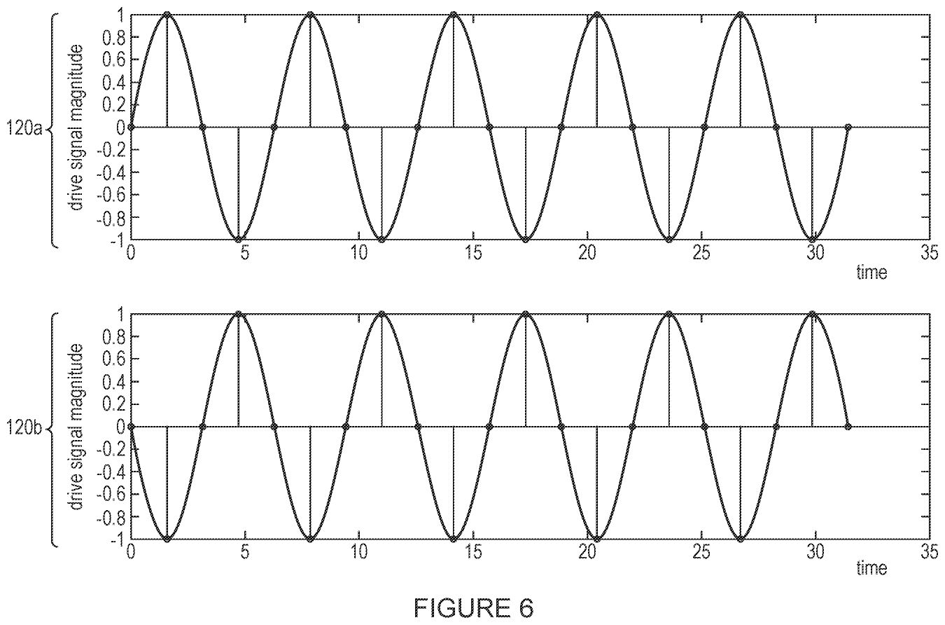

In line with the first approach mentioned earlier, reference is made to FIG. 4, which is a graph showing a desired drive signal having dominant frequency F1 and a series of LRA pulses formed by controlling application of the driving signal having dominant frequency F2. The drive signal magnitude (e.g. in mV) is shown over time (e.g. in ms), and the same applies to FIGS. 6 to 8 described later. As mentioned earlier, the inventors propose creating the “feeling” of the desired low frequency haptic effect by “sampling” the desired drive signal (which would create the desired haptic effect) using high frequency impulses or pulses of the driving signal having dominant frequency F2.

As indicated for the first two pulses in FIG. 4, each such pulse may be a discrete pulse (i.e. separated effectively by non-application of the drive signal, or by a period of time when the drive signal has zero magnitude), and may comprise one or more oscillations of the drive signal. With reference back to FIG. 3, and as shown in FIG. 4 in respect of the first two pulses, the drive signal may be modified such that a leading end of each discrete pulse has a steepened attack profile and/or such that a trailing end of each discrete pulse has a steepened braking profile (as apparent from FIG. 4). The other pulses may be understood accordingly. For example, drive signal may be modified such that the haptic actuator behaves as if an impedance of the haptic actuator 120 and/or the haptic driver 110 had been modified.

As also indicated in FIG. 4, a timing, magnitude and/or polarity of the pulses is configured so that the pulses correspond in timing, magnitude and/or polarity to samples of the desired drive signal. For example, as in FIG. 4, the pulses may correspond in timing to samples of the desired drive signal at its positive and negative peaks, with the polarity of the applied drive signal alternating in line with the positive and negative peaks (local maxima and minima) as indicated explicitly for the first two pulses.

In an alternative arrangement, the pulses may correspond in timing to samples of the desired drive signal at its positive and negative peaks, as shown, but with the polarity of the applied drive signal not alternating in line with the positive and negative peaks. For example, the pulses may (while still corresponding in timing to samples of the desired drive signal at its positive and negative peaks) all have positive polarity, or all have negative polarity, rather than having alternating polarity as shown. For example, it may be that direction of vibration is not perceptible to human touch, only magnitude, enabling “positive” polarity only pulses to be employed with timing that matches the location of local minima and maxima, but giving the same effect as pulses which alternate in polarity in line with the sampling concept discussed above.

Also as apparent from FIG. 4, the spacing between the generated pulses may be selected to accommodate the desired drive signal, i.e. the low frequency pattern. The pulses may be generated at a rate corresponding to the Nyquist rate for the dominant frequency F1 of the desired drive signal. In this way, the ‘feel’ of the desired low-frequency effect may be generated despite driving the haptic actuator with the drive signal having dominant frequency F2.

Of course, any number of pulses may be employed, serving as samples of the desired driving signal (although not necessarily with different polarities) and thus creating the “feeling” of the desired haptic effect for the user. In this respect, different pulses/impulses may have different amplitudes. The series of pulses may comprise positive and negative pulses, or only positive pulses or only negative pulses, in terms of polarity. Also, it will be appreciated that the desired drive signal may have arbitrary waveform, with the pulses/impulses sampling that waveform and thus creating or emulating the corresponding desired haptic effect.

The desired haptic effect may be generated using a plurality of haptic actuators.

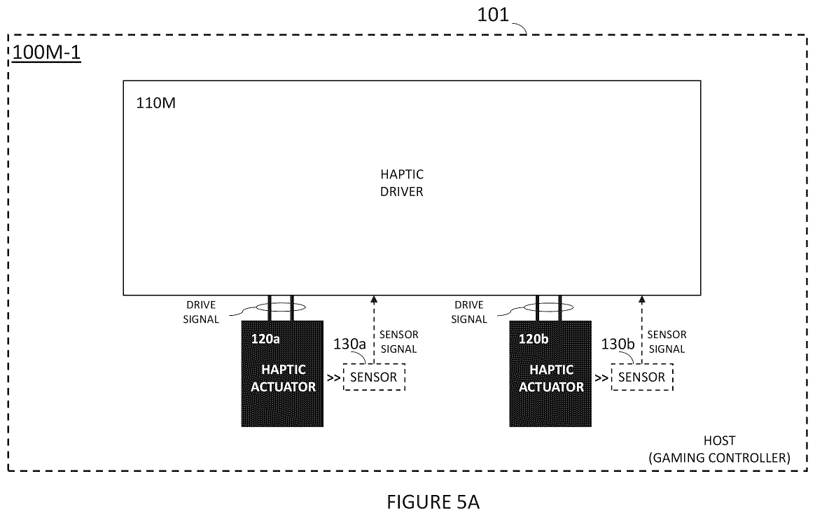

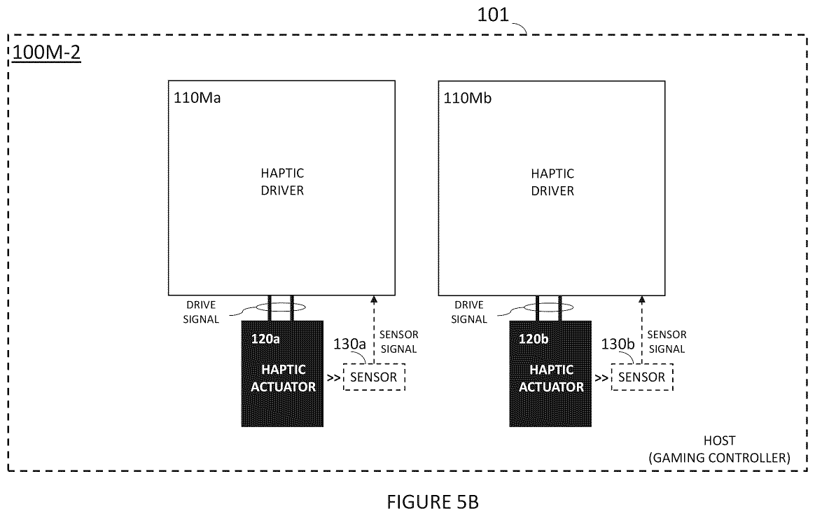

FIG. 5A is a schematic diagram of a host 100M-1, embodying the present invention. The host 100M-1 is the same as the host 100 except that it comprises a plurality of haptic actuators 120a and 120b and, optionally, a corresponding plurality of sensors 130a and 130b. The haptic driver 110M corresponds to the haptic driver 110 except that it is configured to drive the plurality of haptic actuators 120a and 120b. As such, duplicate description may be omitted.

With reference to FIG. 2, the haptic actuator 120a may be considered a first haptic actuator and correspond to the haptic actuator 120 with the drive signal (first drive signal) of the haptic actuator 120a being the same as that of the haptic actuator 120. The haptic actuator 120b may then be considered a second haptic actuator, with the haptic driver 110M configured to drive the second haptic actuator with a second drive signal. Specifically, the haptic driver 110M may be configured to drive the second haptic actuator 120b with a second drive signal having a dominant frequency F2b, and to control how the second drive signal is applied to the second haptic actuator 120b to generate a haptic effect that at least partly emulates a desired haptic effect having a dominant frequency F1b, where F2b≠F1b. In the running example, F2b>F1b, or F2b>>F1b. It may be that F2b is substantially the same as F2, and/or that F1b is substantially the same as F1.

FIG. 5B is a schematic diagram of a host 100M-2, embodying the present invention. The host 100M-2 is the same as the host 100M-1 except that the haptic actuators 120a and 120b are driven by respective haptic drivers 110Ma and 110 Mb, each of which corresponds to the haptic driver 110. The haptic driver 110Ma thus generates the first drive signal and the haptic driver 100Mb generates the second drive signal. The combination of the haptic drivers 110Ma and 110Mb corresponds to the haptic driver 100M, and, as such, duplicate description may be omitted.

As an example relating to the first approach, FIG. 6 presents graphs corresponding to that of FIG. 4, one for driving the first haptic actuator 120a and the other for driving the second haptic actuator 120b. In this example, F2=F2b and F1=F1b. Moreover, the first drive signal for the first haptic actuator 120a is the same as the drive signal for the haptic actuator 120 (and, as such, duplicate description is omitted), and the second drive signal for the second haptic actuator 120b is a complementary signal to the first drive signal. That is, the applied first drive signal and the applied second drive signal are controlled to be substantially out of phase with one another, preferably substantially 180° out of phase with one another, and/or to be mutually complementary signals. This leads to a series of pairs of pulses, where in each pair the two pulses are complementary signals or have opposite polarities, as may be appreciated by a comparison of FIGS. 4 and 6.

In another arrangement, the first drive signal and the second drive signal may be substantially in phase with one another, and may even be substantially the same as one another. In general, the first drive signal and the second drive signal may be synchronized with one another. Other phase differences are also possible, for example 45° or 90°.

The first haptic actuator 120a and the second haptic actuator 120b may be mounted such that their axes of vibration are colinear, mutually parallel, mutually perpendicular, or arranged at arbitrary angles to one another (in two or three dimensions). Where the axes are colinear the first drive signal and the second drive signal may be substantially in phase with one another, although in some arrangements those signals may not be in phase with one another and may even be in antiphase. Generally, the axes of vibration may be configured relative to one another, and the phases of the first drive signal and the second drive signal may be configured relative to one another, differently for different applications.

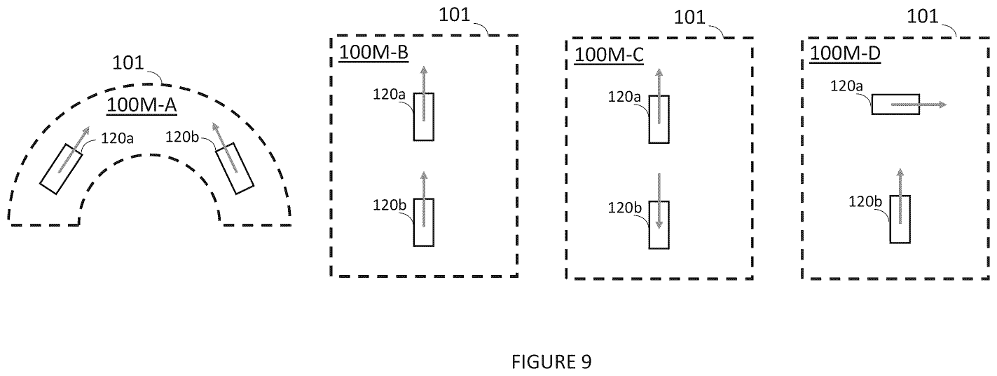

Of course, the host 100M-1 or 100M-2 may have any number of haptic actuators and its haptic driver 110M or haptic drivers 110Ma and 110Mb may be configured to drive them with corresponding drive signals. The considerations regarding relative axes of vibration and relative phases of drive signal thus apply for any number of haptic actuators, and there may be different configurations for different applications. A number of examples are given in FIG. 9 described in more detail below.

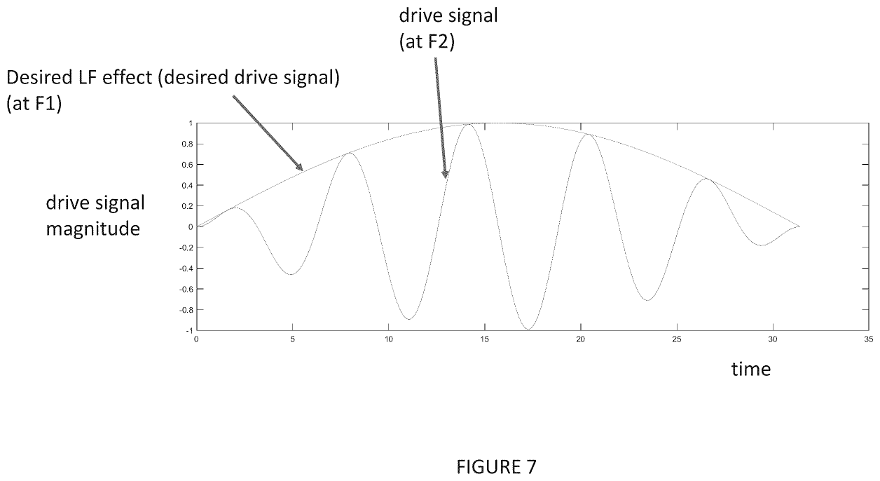

In line with the second approach mentioned earlier and returning to the host 100 of FIG. 2, reference is made to FIG. 7, which is a graph showing a desired drive signal having dominant frequency F1 and a drive signal having dominant frequency F2, the drive signal being amplitude modulated so that its envelope corresponds to the desired drive signal. As mentioned earlier, the inventors propose creating the “feeling” of the desired low frequency haptic effect (corresponding to the desired drive signal) by amplitude modulating a high frequency signal (at or near the resonance frequency of the actuator) with a low frequency envelope. The amplitude modulation may be controlled to correspond to the signal envelope of the desired low frequency effect.

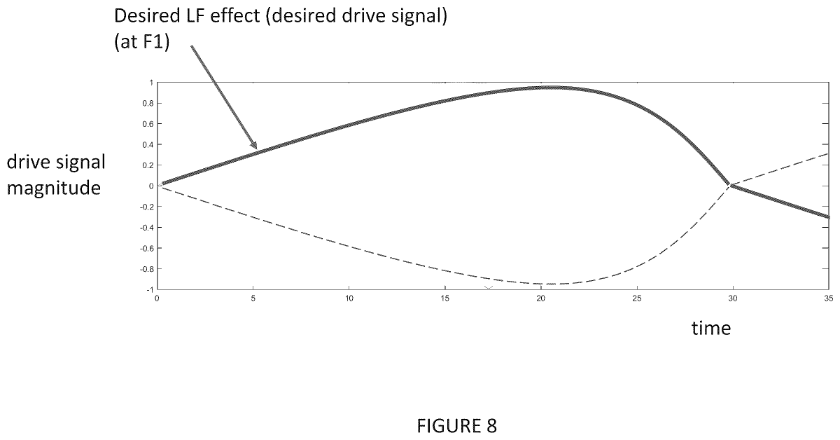

As in FIG. 7, the drive signal may be modulated so that an envelope of the applied drive signal comprises at least a portion of the desired drive signal. For example, the portion of the desired drive signal may comprise at least 30%, 40% or 50% of a period or complete oscillation of the desired drive signal. That is, the user may experience the desired haptic effect, or the generated haptic effect may be sufficient, even if the drive signal is amplitude modulated for only a portion of the desired drive signal. Generally, the modulating signal (i.e. the desired drive signal) should repeat itself at the same period as that of the desired low frequency effect. The waveform “shape” could be arbitrary, as explained in connection with FIG. 8, but is advantageously smooth to avoid artifacts.

FIG. 8 is a graph corresponding to that of FIG. 7 but useful for understanding that the desired drive signal may have arbitrary waveform shape. For simplicity, the drive signal having dominant frequency F2 is not shown but will be understood to be present and amplitude modulated so that its envelope corresponds to the desired drive signal which is shown. To assist in this understanding, the complementary envelope has also been shown in dashed form. As mentioned earlier, the desired drive signal and/or the desired haptic effect having the dominant frequency F1 may have at least one of: a periodic waveform; a sinusoidal, triangle, square, rectangular, positive-ramp sawtooth, or negative-ramp sawtooth waveform; a modified sinusoidal waveform, having a slow rise and fast fall; an irregular waveform; and a customised waveform, optionally defined by one or more custom parameters.

It will be appreciated that multiple haptic actuators may be employed also for this second approach, in line with the host 100M-1 of FIG. 5A (or host 100M-2 of FIG. 5B) for example with first and second haptic actuators 120a and 120b being driven by corresponding drive signals. The first drive signal for the first haptic actuator 120a may be the same as the drive signal for the haptic actuator 120 of FIG. 2 (and as such, duplicate description is omitted) as shown in FIG. 7, and the second drive signal for the second haptic actuator 120b may be a complementary signal to the first drive signal. That is, the applied first drive signal and the applied second drive signal may be controlled to be substantially out of phase with one another, preferably substantially 180° out of phase with one another, and/or to be mutually complementary signals.

As with the first approach above, this is simply an example, and in-phase drive signals are also envisaged for the second approach. Also, the axes of vibration of the first and second haptic actuators 120a and 120b may similarly be colinear, mutually parallel, mutually perpendicular, or arranged at arbitrary angles to one another (in two or three dimensions). The host 100M-1 or 100M-2 may have any number of haptic actuators and its haptic driver 110M or haptic drivers 110Ma and 110Mb may be configured to drive them with corresponding drive signals. The considerations regarding relative axes of vibration and relative phases of drive signal thus apply for any number of haptic actuators equally for this second approach, and there may be different configurations for different applications. A number of examples are again given in FIG. 9 described in more detail below.

Although not shown in the drawings, the haptic driver 110 or 110M, or the haptic drivers 110Ma and 110Mb, may be configured to receive a command signal indicative of the desired haptic effect and/or the dominant frequency F1 and/or the waveform of the desired haptic effect, and be configured to control how the drive signal is applied to the haptic actuator based on the command signal. That is, the haptic driver 110 or 110M, or the haptic drivers 110Ma and 110Mb, may receive an indication of a desired haptic effect to be output by the haptic actuator(s), the haptic effect having a frequency different from the resonant frequency of the haptic actuator(s).

The indication of a desired haptic effect may comprise a time-varying signal originally intended for a different actuator type (e.g., an ERM), or may comprise data specifying a particular type of effect to be generated (e.g., generate a 30 Hz tone for a defined time period). Based on the command signal, the desired low-frequency effect or desired drive signal may be mapped or transformed into an adjusted (high-frequency) drive signal, or set of drive signals, based on the techniques disclosed herein, where the adjusted high-frequency drive signal(s) emulates or recreates the desired low-frequency effect to a user. Such a command signal may be generated within the host 100 or 100M-1 or 100M-2, or may be an external signal received from another device or system.

It will be appreciated that, where a plurality of haptic actuators are employed, those actuators may be used in combination to generated the desired haptic effect. Taking the host 100M-1 as an example, the host 100M-1 may be considered to comprise N haptic actuators HAx, where x=1 to N, and where N>2. The haptic driver 110M-1 may be configured to drive each of the N haptic actuators 120x (where actuators 120a and 120b are examples) with a corresponding drive signal DSx having a corresponding dominant frequency F2x. Further, the haptic driver 110M-1 may be configured to control, for each of the N haptic actuators HAx, how its drive signal DSx is applied to its haptic actuator HAx to generate, with the N haptic actuators, a haptic effect that at least partly emulates a desired haptic effect having a dominant frequency F1, where each dominant frequency F2x is different from (e.g. larger than, or much larger than) F1. In this sense, the N haptic actuators may collectively create the haptic effect that at least partly emulates the desired haptic effect.

FIG. 9, mentioned above, is a schematic diagram showing different example arrangements of haptic actuators in corresponding example hosts 100M-A, 100M-B, 100M-C and 100M-D.

Each of hosts 100M-A, 100M-B, 100M-C and 100M-D may be considered a detailed implementation of host 100M-1 or 100M-2, and thus duplicate description is omitted. The hosts 100M-A, 100M-B, 100M-C and 100M-D are provided simply to better understand relative arrangements between multiple haptic actuators in terms of axes of vibration and phases of drive signal.

In each of hosts 100M-A, 100M-B, 100M-C and 100M-D, two haptic actuators 120a and 120b are shown in line with FIGS. 5A and 5B, but any number of haptic actuators may be employed. Also, in each of hosts 100M-A, 100M-B, 100M-C and 100M-D, for each of the haptic actuators 120a and 120b, a direction of orientation of the axis of vibration is indicated by the orientation of an arrow. Also, the relative direction of the arrows indicates whether the phases of the drive signals are in phase (arrows pointing in the same direction) or out of phase (arrows pointing in opposite directions). Further, the orientations are shown as relative to one another in two dimensions, however it will be appreciated that relative orientations may be in three dimensions.

In host 100M-A, the haptic actuators 120a and 120b may be considered to have arbitrary relative locations and their axes of vibration may similarly be considered to have arbitrary relative orientations. The enclosure 101 is shown to have a particular shape (represented schematically) in which the relative locations/orientations may be appropriate.

In host 100M-B, the enclosure 101 is understood to have arbitrary shape (in three dimensions), as in FIGS. 2, 5A and 5B. The haptic actuators 120a and 120b may be considered mounted so that their axes of vibration are colinear (co-axially mounted). The drive signals for the haptic actuators 120a and 120b may be in phase as shown. This may avoid one actuator attenuating the effect of the other for example.

In host 100M-C, the enclosure 101 is understood to have arbitrary shape (in three dimensions. The haptic actuators 120a and 120b may be considered mounted so that their axes of vibration are colinear (co-axially mounted). The drive signals for the haptic actuators 120a and 120b may be in antiphase as shown. This may be appropriate in some applications.

In host 100M-D, the enclosure 101 is again understood to have arbitrary shape (in three dimensions). The haptic actuators 120a and 120b may be considered mounted so that their axes of vibration are mutually perpendicular (perpendicularly mounted). The drive signals for the haptic actuators 120a and 120b may be as shown.

In the running example, the hosts disclosed herein have been gaming controllers. However, the present invention is applicable in other fields, for example in the automotive industry. The host may for example be an automotive system, such as a seat, seatback, headrest, handle, in-vehicle console or controller or human-machine interface, gearstick, steering wheel, or HVAC (Heating, Ventilation and Air Conditioning) control. The present invention may be applicable in the field of wearable technology, including watches. The host may for example be a haptic-enabled wearable device. The present invention may be applicable in the field of personal computers, laptops, tablet computers and notebooks. The host may for example be a haptic-enabled trackpad. In general. the host may be an electrical or electronic device, or a haptic-enabled device.

The skilled person will recognise that some aspects of the above-described apparatus (circuitry), devices and methods may be embodied as processor control code, for example on a non-volatile carrier medium such as a disk, CD- or DVD-ROM, programmed memory such as read only memory (Firmware), or on a data carrier such as an optical or electrical signal carrier. For example, any of the haptic drivers 110 and 110M may be implemented as a processor operating based on processor control code.

For some applications, such aspects will be implemented on a DSP (Digital Signal Processor), ASIC (Application Specific Integrated Circuit) or FPGA (Field Programmable Gate Array). Thus the code may comprise conventional program code or microcode or, for example, code for setting up or controlling an ASIC or FPGA. The code may also comprise code for dynamically configuring re-configurable apparatus such as re-programmable logic gate arrays. Similarly, the code may comprise code for a hardware description language such as Verilog™ or VHDL. As the skilled person will appreciate, the code may be distributed between a plurality of coupled components in communication with one another. Where appropriate, such aspects may also be implemented using code running on a field-(re) programmable analogue array or similar device in order to configure analogue hardware.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in the claim, “a” or “an” does not exclude a plurality, and a single feature or other unit may fulfil the functions of several units recited in the claims. Any reference numerals or labels in the claims shall not be construed so as to limit their scope.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

It should be understood—especially by those having ordinary skill in the art with the benefit of this disclosure—that the various operations described herein, particularly in connection with the figures, may be implemented by other circuitry or other hardware components. The order in which each operation of a given method is performed may be changed, and various elements of the systems illustrated herein may be added, reordered, combined, omitted, modified, etc. It is intended that this disclosure embrace all such modifications and changes and, accordingly, the above description should be regarded in an illustrative rather than a restrictive sense.

Similarly, although this disclosure makes reference to specific embodiments, certain modifications and changes can be made to those embodiments without departing from the scope and coverage of this disclosure. Moreover, any benefits, advantages, or solutions to problems that are described herein with regard to specific embodiments are not intended to be construed as a critical, required, or essential feature or element. Further embodiments likewise, with the benefit of this disclosure, will be apparent to those having ordinary skill in the art, and such embodiments should be deemed as being encompassed herein.

To aid the Patent Office (USPTO) and any readers of any patent issued on this application in interpreting the claims appended hereto, applicants wish to note that they do not intend any of the appended claims or claim elements to invoke 35 U.S.C. § 112 (f) unless the words “means for” or “step for” are explicitly used in the particular claim.

There is considered herein a method to create low frequency effects with an actuator that has high frequency resonance using amplitude modulation. The signal (drive signal) modulated may have a frequency equal to the resonance frequency of the actuator (power savings). The modulating signal may be a sinusoidal matching the low frequency of the desired effect. The modulating signal may be arbitrarily adapted to generate the desired effect.

There is also considered herein a method to create low frequency effects with an actuator that has high frequency resonance using high frequency pulses/impulses. An arbitrary number of impulses (of the same or varying amplitudes) may be used to achieve LF (low frequency) “feeling”. The pulses may serve as samples of the desired drive signal. The impulses (pulses) may be controlled with active braking. The impulses may be driven in closed loop (i.e. in line with FIG. 3, right-hand side), e.g. using a velocity control system.

There is also considered herein a method to create low frequency effects using multiple actuators with high frequency resonance. Two or more actuators may be used in synchrony. Different actuators recreate different portions of the waveforms played (time multiplexing).

The present disclosure extends to the following statements:
1. There is provided a system and method for driving an actuator having a resonant frequency, preferably a haptic actuator such as an LRA or a VCM, comprising:
   receiving an indication of a desired effect to be output by the actuator (e.g. a haptic vibration), the desired effect having a relatively low frequency, preferably where the desired effect has a primary or dominant frequency F1 lower than the resonant frequency of the actuator;
   generating a haptic driving signal based on the received indication, wherein the haptic driving signal has a relatively high frequency, preferably the haptic driving signal has a primary or dominant frequency F2, wherein F2>F1; and driving an actuator using the haptic driving signal, wherein the haptic driving signal is generated to emulate the feeling of the desired effect to a user.
2. Preferably, the haptic driving signal is generated to have a primary or dominant frequency (F2) at or near the resonant frequency of the actuator.
3. Preferably, the desired effect has a primary or dominant frequency (F1) below 100 Hz, further preferably in the range of 20-80 Hz.
4. Preferably, the haptic driving signal has a primary or dominant frequency (F2) above 100 Hz, further preferably above 150 Hz.
5. Preferably, the step of generating comprises mapping or transforming a low-frequency signal into an adjusted high-frequency signal, where the adjusted high-frequency signal emulates or recreates the effect of a low frequency signal to a user of the system and method.
6. In one aspect, the step of generating a haptic driving signal comprises generating a series of high-frequency impulses, preferably positive and negative impulses.
7. Preferably, the spacing and magnitude of the high-frequency impulses are selected such that the maximum magnitude values of the impulses recreate a sampled version of a desired low-frequency signal.
8. In a preferred aspect, the spacing and magnitude of the impulses are selected such that the maximum magnitude of the impulses corresponds with the local maxima or local minima of the desired low-frequency signal. In one aspect, the impulses are generated at a rate equivalent to the Nyquist rate for the low-frequency signal.
9. In an alternative aspect, the step of generating a haptic driving signal comprises amplitude modulating a high-frequency signal, wherein the amplitude modulation is adjusted such that the haptic driving signal corresponds to the signal envelope of a desired low-frequency effect.
10. In a preferred aspect, the haptic driving signal may be generated only for a portion of the signal envelope of a desired low frequency effect, preferably a starting portion of signal envelope.
11. There provided an integrated circuit (IC) arranged to implement the above-described system and method.
12. There is further provided an integrated circuit (IC) comprising:
   a haptic driver output stage to be coupled with a haptic actuator; and
   a Digital Signal Processor (DSP) to generate a haptic driving signal to be output by the haptic driver output stage,
   wherein the DSP receives an indication of a haptic effect to be generated by a coupled haptic actuator, and transforms the received indication to a haptic driving signal to be output by the haptic driver output stage. Preferably, the haptic driving signal has a primary or dominant frequency higher than a primary or dominant frequency of the haptic effect to be generated.
13. There is further provided a mobile device, such as a mobile phone, a laptop, a tablet computer, a gaming controller, or a wearable device, the mobile device comprising a haptic actuator and an IC as described above to drive the haptic actuator.
14. In an alternative aspect, there is provided a controller IC to be coupled with a haptic driver IC, wherein the controller IC is arranged to implement the above-described system and method in combination with a separate haptic driver IC.
15. Preferably, the haptic actuator is a linear resonant actuator (LRA) or a voice coil motor (VCM).
S1. A gaming controller, comprising:
   a haptic actuator; and
   a haptic driver,
   wherein the haptic driver is configured to drive the haptic actuator with a drive signal having a dominant frequency F2, and to control how the drive signal is applied to the haptic actuator to generate a haptic effect that at least partly emulates a desired haptic effect having a dominant frequency F1, where F2>F1.
S2. The gaming controller of statement S1, wherein:
   F2 is at or near a resonant frequency F0 of the haptic actuator; and/or
   F2 is above 100 Hz, further preferably above 150 Hz; and/or
   F1 is below 100 Hz, further preferably in the range 20-80 Hz; and/or
   F1 and F2 are set such that a gain from driving signal to haptic actuator response at F1 is A times lower than at F2, where A>2, optionally where A>5, optionally where A>10.
S3. The gaming controller of statement S1 or S2, wherein the control comprises at least one of:
   controlling when the drive signal is and is not applied to the haptic actuator;
   controlling a magnitude of the applied drive signal;
   controlling a phase of the applied drive signal;
   controlling a polarity of the applied drive signal;
   controlling a value of F2, optionally to track F0;
   modifying the drive signal such that a leading end of a discrete pulse of the applied drive signal has a steepened attack profile and/or such that a trailing end of a discrete pulse of the applied drive signal has a steepened braking profile; and
   modifying the drive signal such that the haptic actuator behaves as if an impedance of the haptic actuator and/or the haptic driver had been modified.
S4. The gaming controller of any of the preceding statements, wherein the haptic actuator is or comprises at least one of:
   a linear resonant actuator, LRA; and
   a voice coil motor, VCM.
S5. The gaming controller of any of the preceding statements, wherein the control comprises controlling the drive signal such that the applied drive signal at least partly emulates a desired drive signal, the desired drive signal having the dominant frequency F1 and configured to generate the desired haptic effect.
S6. The gaming controller of statement S5, wherein the desired drive signal and/or the desired haptic effect having the dominant frequency F1 has at least one of:
   a periodic waveform;
   a sinusoidal, triangle, square, rectangular, positive-ramp sawtooth, or negative-ramp sawtooth waveform;
   a modified sinusoidal waveform, having a slow rise and fast fall;
   an irregular waveform; and
   a customised waveform, optionally defined by one or more custom parameters.
S7. The gaming controller of any of the preceding statements, wherein the control comprises applying the drive signal as a series of discrete pulses.
S8. The gaming controller of statement S7, wherein each discrete pulse comprises one or more oscillations of the drive signal.
S9. The gaming controller of statement S7 or S8, wherein the control comprises modifying the drive signal such that:
   a leading end of each discrete pulse has a steepened attack profile and/or such that a trailing end of each discrete pulse has a steepened braking profile; and/or
   the haptic actuator behaves as if an impedance of the haptic actuator and/or the haptic driver had been modified.
S10. The gaming controller of any of statements S7 to S9, wherein:
   a timing, magnitude and/or polarity of the pulses is configured so that the pulses correspond in timing, magnitude and/or polarity to samples of the desired drive signal; and/or
   the timing and magnitude of the pulses are selected such that the maximum magnitude values of the pulses recreate a sampled version the desired drive signal.
S11. The gaming controller of statement S10, wherein:
   the pulses correspond in timing to samples of the desired drive signal at its positive and negative peaks; and/or
   the timing and magnitude of the pulses are selected such that the maximum magnitude values of the pulses correspond with the local maxima and/or local minima of the desired drive signal.
S12. The gaming controller of any of statements S7 to S11, wherein the pulses are generated at a rate corresponding to the Nyquist rate for the dominant frequency F1 of desired drive signal.
S13. The gaming controller of any of the preceding statements, wherein the control comprises modulating an amplitude of the drive signal so that an envelope of the applied drive signal comprises at least a portion of the desired drive signal.
S14. The gaming controller of statement S13, wherein the portion of the desired drive signal comprises at least 30%, 40% or 50% of a period or oscillation of the desired drive signal.
S15. The gaming controller of any of the preceding statements, comprising receiving a command signal indicative of the desired haptic effect and/or the dominant frequency F1 and/or the waveform of the desired haptic effect, and controlling how the drive signal is applied to the haptic actuator based on the command signal.
S16. The gaming controller of any of the preceding statements, wherein the haptic actuator is a first haptic actuator and the drive signal is a first drive signal, and wherein:
   the gaming controller comprises a second haptic actuator; and
   the haptic driver is configured to drive the second haptic actuator with a second drive signal having a dominant frequency F2b, and to control how the second drive signal is applied to the second haptic actuator to generate a haptic effect that at least partly emulates a desired haptic effect having a dominant frequency F1b, where F2b>F1b.
S17. The gaming controller of statement S16, wherein:
   F2b is substantially the same as F2 or is different from F2; and/or
   F1b is substantially the same as F1 or is different from F1.
S18. The gaming controller of statement S16 or S17, wherein the applied first drive signal and the applied second drive signal are controlled to:
   be synchronized with one another; or
   be substantially out of phase with one another, preferably substantially 180° out of phase with one another, and/or to be mutually complementary signals; or
   be substantially in phase with one another, and preferably substantially the same as one another; or
   have a target phase difference between one another, optionally wherein the target phase difference is controllable.
S19. The gaming controller of any of statements S16 to S18, wherein the first haptic actuator and the second haptic actuator are mounted such that their axes of vibration are, in two or three dimensions:
   colinear; or
   parallel with one another; or
   perpendicular to one another; or
   neither colinear, nor parallel with one another, nor perpendicular with one another.
S20. The gaming controller of any of the preceding statements, wherein:
   the gaming controller comprises N haptic actuators HAx, where x=1 to N, and where N≥2; and
   the haptic driver is configured to drive each of the N haptic actuators HAx with a corresponding drive signal DSx having a corresponding dominant frequency F2x; and
   the haptic driver is configured to control, for each of the N haptic actuators HAx, how its drive signal DSx is applied to its haptic actuator HAx to generate, with the N haptic actuators, a haptic effect that at least partly emulates a desired haptic effect having a dominant frequency F1, where each dominant frequency F2x is greater than F1.
S21. A gaming controller, comprising:
   N haptic actuators HAx, where x=1 to N, and where N≥1; and
   a haptic driver,
   wherein the haptic driver is configured to:
      drive each of the N haptic actuators HAx with a corresponding drive signal DSx having a corresponding dominant frequency F2x; and
      control, for each of the N haptic actuators HAx, how its drive signal DSx is applied to its haptic actuator HAx to generate, with the N haptic actuators, a haptic effect that at least partly emulates a desired haptic effect having a dominant frequency F1 (or F1x), where each dominant frequency F2x is greater than F1 (or F1x).
S22. A haptic driver for driving a haptic actuator of a gaming controller or automotive system, the haptic driver configured to drive the haptic actuator with a drive signal having a dominant frequency F2, and to control how the drive signal is applied to the haptic actuator to generate a haptic effect that at least partly emulates a desired haptic effect having a dominant frequency F1, where F2>F1.
S23. A haptic-effect generation method, comprising:
   driving a haptic actuator with a drive signal having a dominant frequency F2; and
   controlling how the drive signal is applied to the haptic actuator to generate a haptic effect that at least partly emulates a desired haptic effect having a dominant frequency F1, where F2>F1.

1. A gaming controller, comprising:
a haptic actuator; and
a haptic driver,
wherein the haptic driver is configured to drive the haptic actuator with a drive signal having a dominant frequency F2, and to control how the drive signal is applied to the haptic actuator to generate a haptic effect that at least partly emulates a desired haptic effect having a dominant frequency F1, where F2>F1.

2. The gaming controller of claim 1, wherein:
F2 is at or near a resonant frequency F0 of the haptic actuator; and/or
F2 is above 100 Hz, further preferably above 150 Hz; and/or
F1 is below 100 Hz, further preferably in the range 20-80 Hz; and/or
F1 and F2 are set such that a gain from driving signal to haptic actuator response at F1 is A times lower than at F2, where A>2, optionally where A>5, optionally where A>10.

3. The gaming controller of claim 1, wherein the control comprises at least one of:
controlling when the drive signal is and is not applied to the haptic actuator;
controlling a magnitude of the applied drive signal;
controlling a phase of the applied drive signal;
controlling a polarity of the applied drive signal;
controlling a value of F2, optionally to track F0;
modifying the drive signal such that a leading end of a discrete pulse of the applied drive signal has a steepened attack profile and/or such that a trailing end of a discrete pulse of the applied drive signal has a steepened braking profile; and
modifying the drive signal such that the haptic actuator behaves as if an impedance of the haptic actuator and/or the haptic driver had been modified.

4. The gaming controller of claim 1, wherein the haptic actuator is or comprises at least one of:
a linear resonant actuator, LRA; and
a voice coil motor, VCM.

5. The gaming controller of claim 1, wherein the control comprises controlling the drive signal such that the applied drive signal at least partly emulates a desired drive signal, the desired drive signal having the dominant frequency F1 and configured to generate the desired haptic effect.

6. The gaming controller of claim 5, wherein the desired drive signal and/or the desired haptic effect having the dominant frequency F1 has at least one of:
a periodic waveform;
a sinusoidal, triangle, square, rectangular, positive-ramp sawtooth, or negative-ramp sawtooth waveform;
a modified sinusoidal waveform, having a slow rise and fast fall;
an irregular waveform; and
a customised waveform, optionally defined by one or more custom parameters.

7. The gaming controller of claim 1, wherein the control comprises applying the drive signal as a series of discrete pulses, optionally wherein each discrete pulse comprises one or more oscillations of the drive signal.

8. The gaming controller of claim 7, wherein the control comprises modifying the drive signal such that:
a leading end of each discrete pulse has a steepened attack profile and/or such that a trailing end of each discrete pulse has a steepened braking profile; and/or
the haptic actuator behaves as if an impedance of the haptic actuator and/or the haptic driver had been modified.

9. The gaming controller of claim 7, wherein:
a timing, magnitude and/or polarity of the pulses is configured so that the pulses correspond in timing, magnitude and/or polarity to samples of the desired drive signal; and/or
the timing and magnitude of the pulses are selected such that the maximum magnitude values of the pulses recreate a sampled version the desired drive signal.

10. The gaming controller of claim 9, wherein:
the pulses correspond in timing to samples of the desired drive signal at its positive and negative peaks; and/or
the timing and magnitude of the pulses are selected such that the maximum magnitude values of the pulses correspond with the local maxima and/or local minima of the desired drive signal.

11. The gaming controller of claim 7, wherein the pulses are generated at a rate corresponding to the Nyquist rate for the dominant frequency F1 of desired drive signal.

12. The gaming controller of claim 1, wherein the control comprises modulating an amplitude of the drive signal so that an envelope of the applied drive signal comprises at least a portion of the desired drive signal.

13. The gaming controller of claim 12, wherein the portion of the desired drive signal comprises at least 30%, 40% or 50% of a period or oscillation of the desired drive signal.

14. The gaming controller of claim 1, comprising receiving a command signal indicative of the desired haptic effect and/or the dominant frequency F1 and/or the waveform of the desired haptic effect, and controlling how the drive signal is applied to the haptic actuator based on the command signal.

15. The gaming controller of claim 1, wherein the haptic actuator is a first haptic actuator and the drive signal is a first drive signal, and wherein:
the gaming controller comprises a second haptic actuator; and
the haptic driver is configured to drive the second haptic actuator with a second drive signal having a dominant frequency F2b, and to control how the second drive signal is applied to the second haptic actuator to generate a haptic effect that at least partly emulates a desired haptic effect having a dominant frequency F1b, where F2b>F1b.

16. The gaming controller of claim 15, wherein:
F2b is substantially the same as F2 or is different from F2; and/or
F1b is substantially the same as F1 or is different from F1.

17. The gaming controller of claim 15, wherein the applied first drive signal and the applied second drive signal are controlled to:
be synchronized with one another; or
be substantially out of phase with one another, preferably substantially 180° out of phase with one another, and/or to be mutually complementary signals; or
be substantially in phase with one another, and preferably substantially the same as one another; or
have a target phase difference between one another, optionally wherein the target phase difference is controllable.

18. The gaming controller of claim 15, wherein the first haptic actuator and the second haptic actuator are mounted such that their axes of vibration are, in two or three dimensions:
colinear; or
parallel with one another; or
perpendicular to one another; or
neither colinear, nor parallel with one another, nor perpendicular with one another.

19. The gaming controller of claim 1, wherein:
the gaming controller comprises N haptic actuators HAx, where x=1 to N, and where N≥2; and
the haptic driver is configured to drive each of the N haptic actuators HAx with a corresponding drive signal DSx having a corresponding dominant frequency F2x; and
the haptic driver is configured to control, for each of the N haptic actuators HAx, how its drive signal DSx is applied to its haptic actuator HAx to generate, with the N haptic actuators, a haptic effect that at least partly emulates a desired haptic effect having a dominant frequency F1, where each dominant frequency F2x is greater than F1.

20. A gaming controller, comprising:
N haptic actuators HAx, where x=1 to N, and where N≥1; and
a haptic driver,
wherein the haptic driver is configured to:
drive each of the N haptic actuators HAx with a corresponding drive signal DSx having a corresponding dominant frequency F2x; and
control, for each of the N haptic actuators HAx, how its drive signal DSx is applied to its haptic actuator HAx to generate, with the N haptic actuators, a haptic effect that at least partly emulates a desired haptic effect having a dominant frequency F1, where each dominant frequency F2x is greater than F1.
